(19) United States
(12) Patent Application Publication
(10) Pub. No.: US 2006/0163309 A1
(43) Pub. Date: Jul. 27, 2006

(54) Tool for mechanically machining workpieces

(76) Inventors: Robert Merk, Lamerdingen (DE); Otto Bruntrup, Munchen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/529,109

(22) PCT Filed: Oct. 17, 2003
(86) PCT No.: PCT/EP03/11523

§ 371 Date: Mar. 24, 2005

(30) Foreign Application Priority Data
Oct. 21, 2002 (DE) 10249109.7

(51) Int. Cl. B25C 3/00

(52) U.S. Cl. 227/107

(57) ABSTRACT

The invention relates to a tool for the mechanical processing of workpieces, in particular for the joining, self-piercing riveting or clinching of sheet, tube or profile parts, having tool-insert carriers which are movable relative to one another and to the working ends of which a respective tool insert of a tool set can be fastened, and having an electric-motor drive which acts on a plunger of at least one tool-insert carrier for performing a working stroke, the drive comprising as drive member a cam disk (21) which can be driven by a shaft (32) of a motor (31) and controls a positive motion of a stroke member which is formed by a rocker (16) which is pivotably mounted about a fixed axis (16.1) perpendicularly to a working stroke direction of the movable tool-insert carrier (1, 2) and whose free end (17) moves a plunger (9) guided in the working stroke direction.

The invention relates to a tool for the mechanical processing of workpieces, in particular sheets, tube or profile parts, according to the preamble of claim 1.

For sheet-metal processing, DE 197 31 222 A1 discloses a device for self-piercing riveting, in which device a punch and possibly a hold-down are driven via a transmission unit. The transmission unit converts the rotary movement of an electric-motor drive unit into a translatory movement of the punch or the hold-down, as a result of which a complicated hydraulic drive is avoided. To this end, the punch is connected to the transmission unit, which has gearing, via a spindle drive. The transmission unit and the spindle drive result in a marked increase in the tool size and increase the design outlay.

The object of the invention is therefore to provide a tool according to the preamble of claim 1 which is of convenient and simple design.

This object is achieved by the features of claim 1.

As a result, a tool is provided in which a rotary movement of an electric-motor drive is converted into a translatory movement by a mechanical conversion. The cam disk provided for this purpose controls a rocker which acts on the plunger of a movable tool-insert carrier and lifts and lowers the plunger by its reciprocating movement. The plunger guided in the working stroke direction therefore performs a translatory movement. Consequently, in a simple manner, a rotary movement is transmitted to a plunger by an electric-motor drive in order to allow said plunger to perform working strokes.

That end of the rocker which is in engagement with the plunger is preferably mounted on the plunger via a sliding guide. In this case, the end of the rocker is of cylindrical or dome-shaped design in order to compensate for the oscillation angle of the rocker. A bearing slide, in particular a bearing shell, is preferably displaceable perpendicularly to the direction of movement of the plunger and accommodates the end of the rocker in an articulated manner. Alternatively, the free end of the rocker may be accommodated by an eccentric ball bush. As a result, a low-wear bearing arrangement of the end of the rocker on the plunger is ensured.

The rocker is preferably formed by a double-armed lever which oscillates back and forth about a fixed fulcrum, the lever arm lengths of which being selectable for setting a certain plunger displacement. In addition, the lever arms are preferably designed to be of different length so that positive driving is effected by the cam disk via a short connecting member.

The cam disk preferably comprises a closed, groove-shaped curved track about a center cam disk core. For low-wear positive driving of the drive end of the rocker on the cam disk, said end is preferably of journal-shaped design and sits in a bush-shaped sliding bearing arranged in the groove-shaped curved track. A rotation axis of the cam disk preferably runs perpendicularly to the fixed axis of the rocker and is spatially offset from said fixed axis in such a way that the rocker is essentially parallel to the rotation axis of the cam disk in a working position of the plunger, for example a clinching position. The drive force is then transmitted in an especially low-wear manner.

The cam disk can be configured individually with regard to the stroke effected by it, so that the stroke lengths of the plunger of a movable tool-insert carrier can be selected in accordance with the intended purpose. The gradient profile of the curve line of the curved track can also be selected individually, so that the increase in force during the working stroke can be effected more slowly or more quickly than the drop in force during the retraction of the plunger. In addition, a maximum force can be maintained during a time interval.

The plunger may be of two-piece design in order to set a fixed basic feed of the plunger, which may constitute an effective change in length of the plunger. To this end, the plunger may comprise a working plunger and a stroke plunger which are displaceable relative to one another in the working stroke direction via an adjusting device. To this end, the adjusting device may have a thread which is in engagement with different thread turns in the working plunger and in the stroke plunger. If the thread turn in the region of the working plunger and the stroke plunger is chosen to be different, rotation of the adjusting device leads to a displacement of the working plunger relative to the stroke plunger. Alternatively, the setting may be effected by an eccentric ball bush which accommodates the free end of the rocker.

A rectilinear guide may be provided for guiding the plunger in the working stroke direction.

The tool can be fitted into the legs of pliers.

Further configurations of the invention can be gathered from the description below and from the subclaims.

The invention is explained in more detail below with reference to the exemplary embodiments shown in the attached figures.

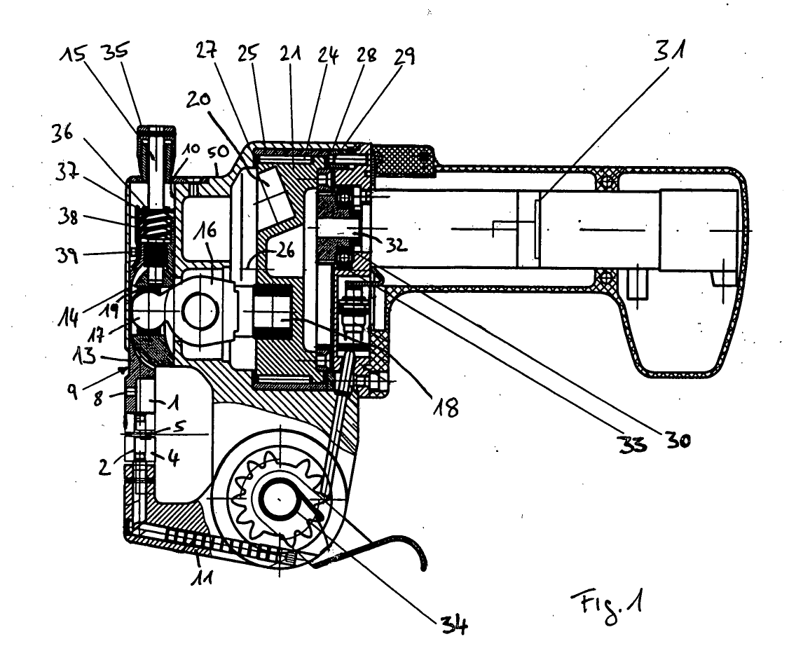

FIG. 1 schematically shows a longitudinal section of a first exemplary embodiment of a tool for the mechanical processing of workpieces,

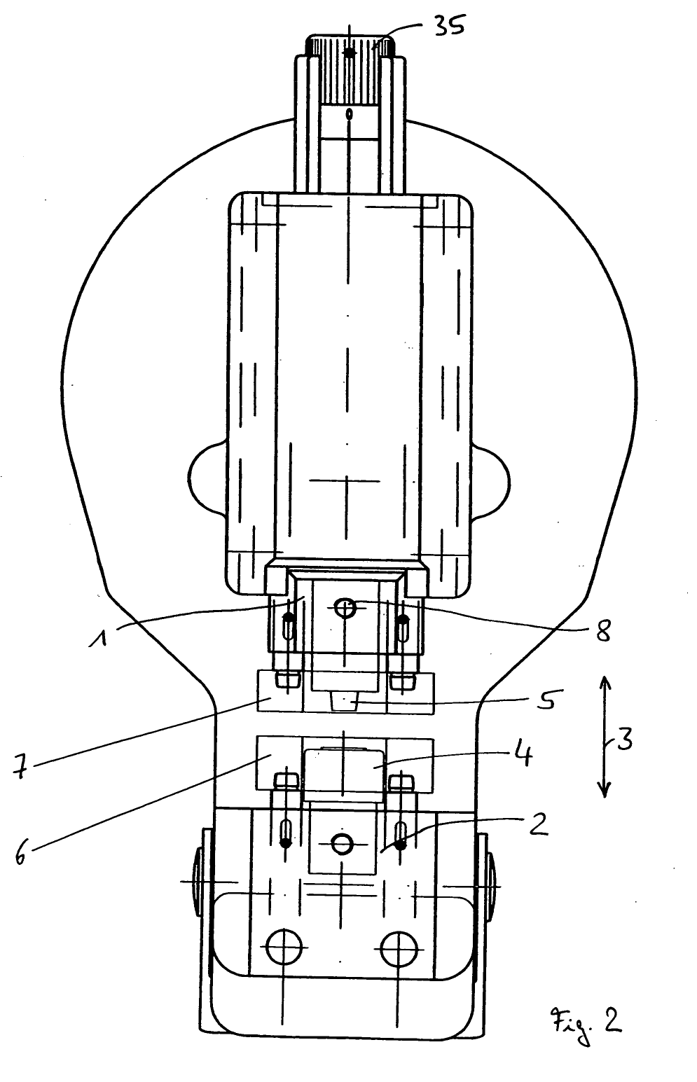

FIG. 2 schematically shows a front view of the tool according to FIG. 1,

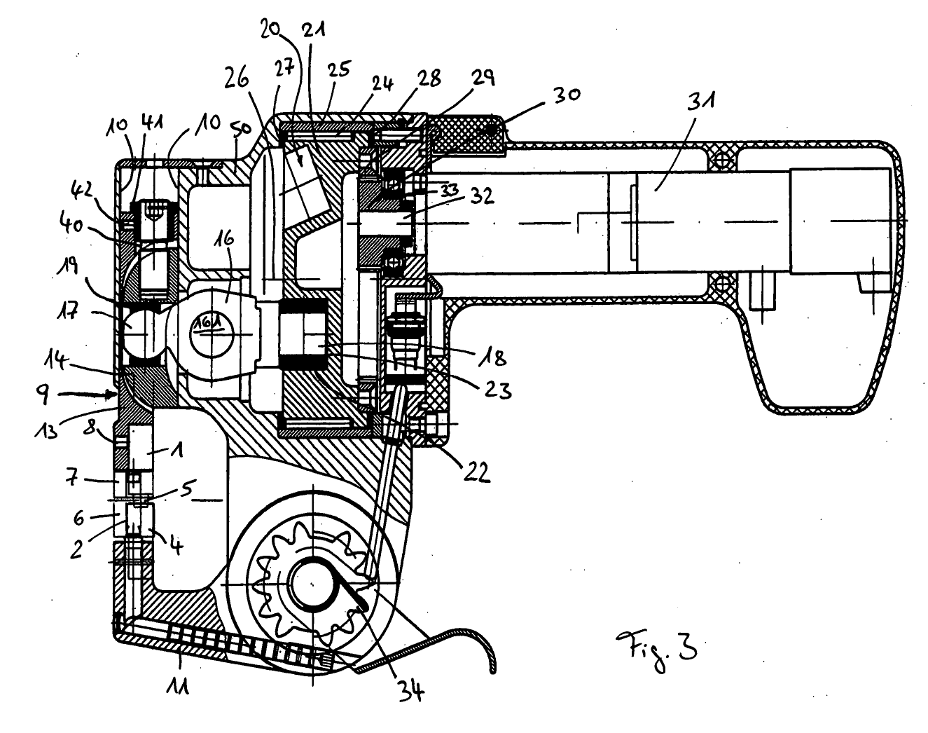

FIG. 3 schematically shows a longitudinal section of a second exemplary embodiment of a tool for the mechanical processing of workpieces in a working position of the tool set,

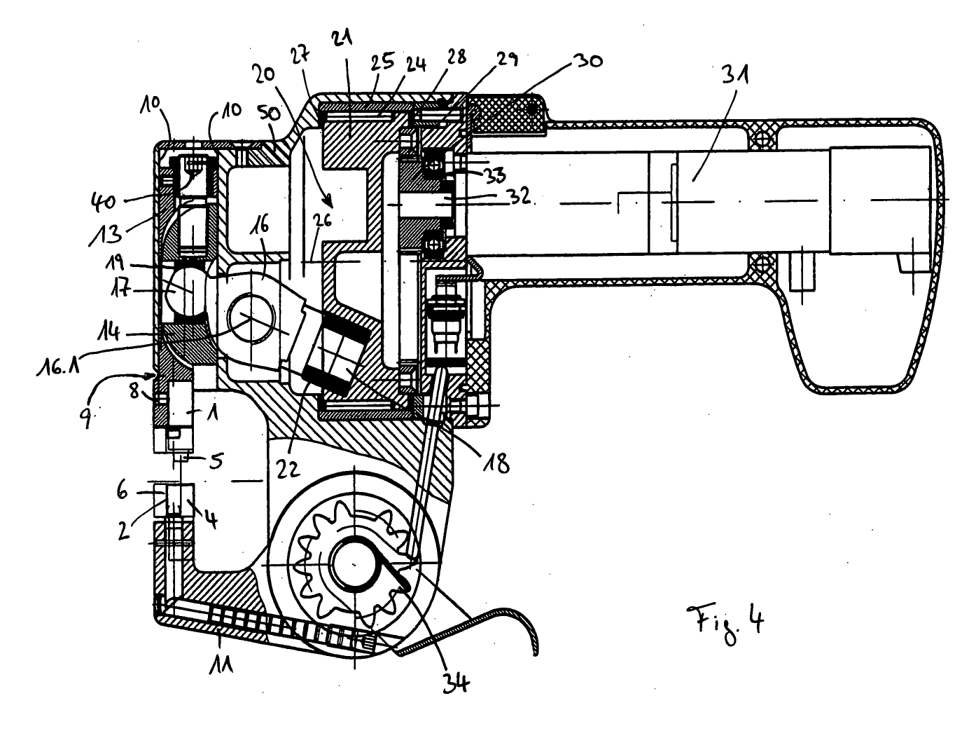

FIG. 4 schematically shows the tool according to FIG. 3 in the open position of the tool set,

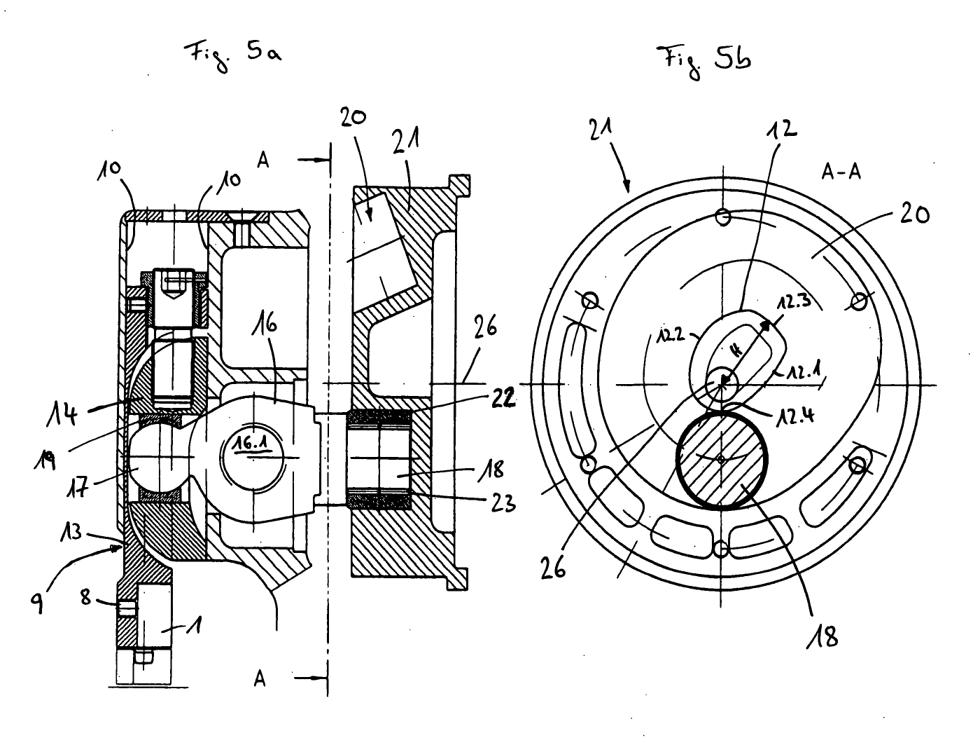

FIG. 5a shows an enlarged part of the tool from FIG. 3 in the region of the rocker for a working position of the tool,

FIG. 5b shows a section along A-A according to FIG. 5a,

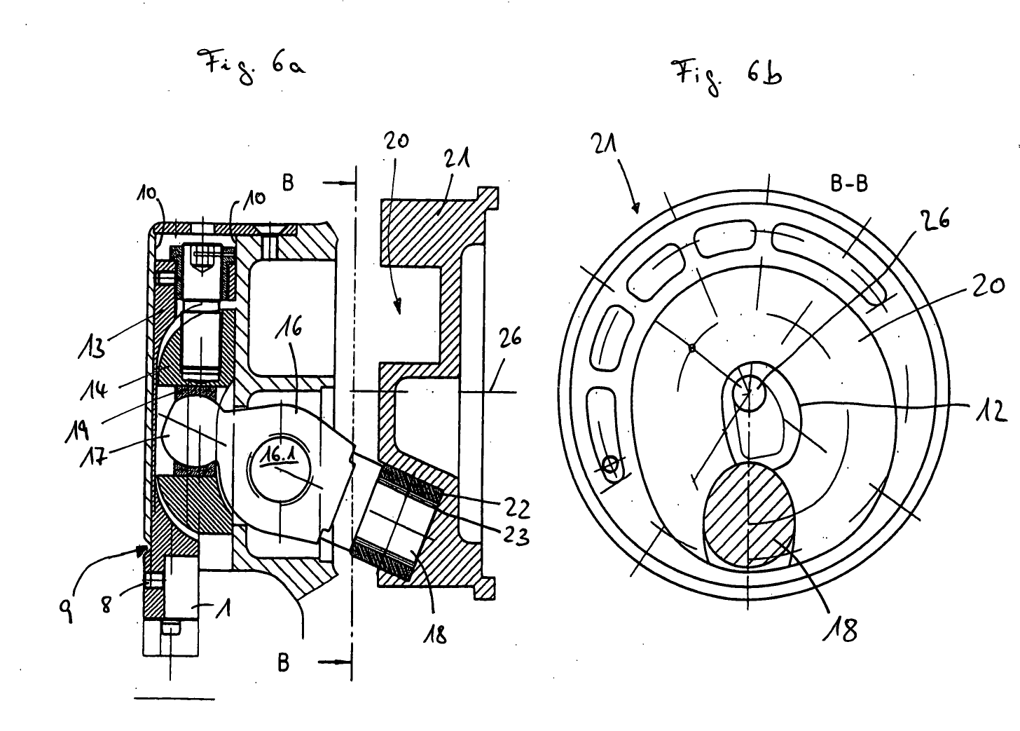

FIG. 6a shows an enlarged part of the tool from FIG. 4 in the region of the rocker for an open position of the tool,

FIG. 6b shows a section along B-B according to FIG. 6a,

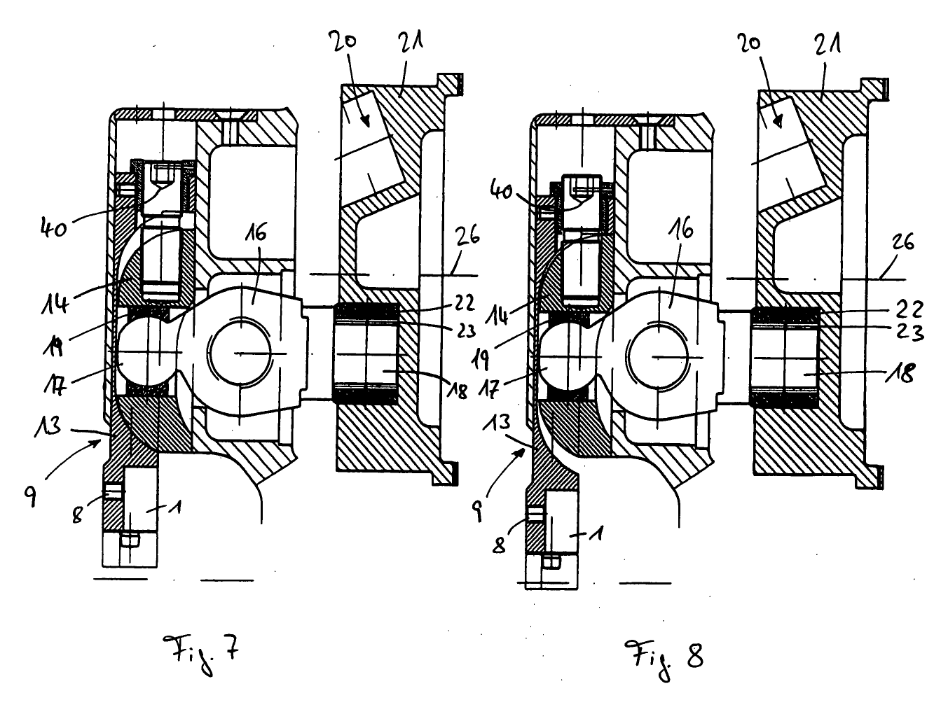

FIG. 7 shows an enlarged part of the tool from FIG. 3 in the region of the rocker, with working plunger arranged in a topmost position,

FIG. 8 shows an enlarged part of the tool from FIG. 3 in the region of the rocker, with a working plunger arranged in a bottommost position,

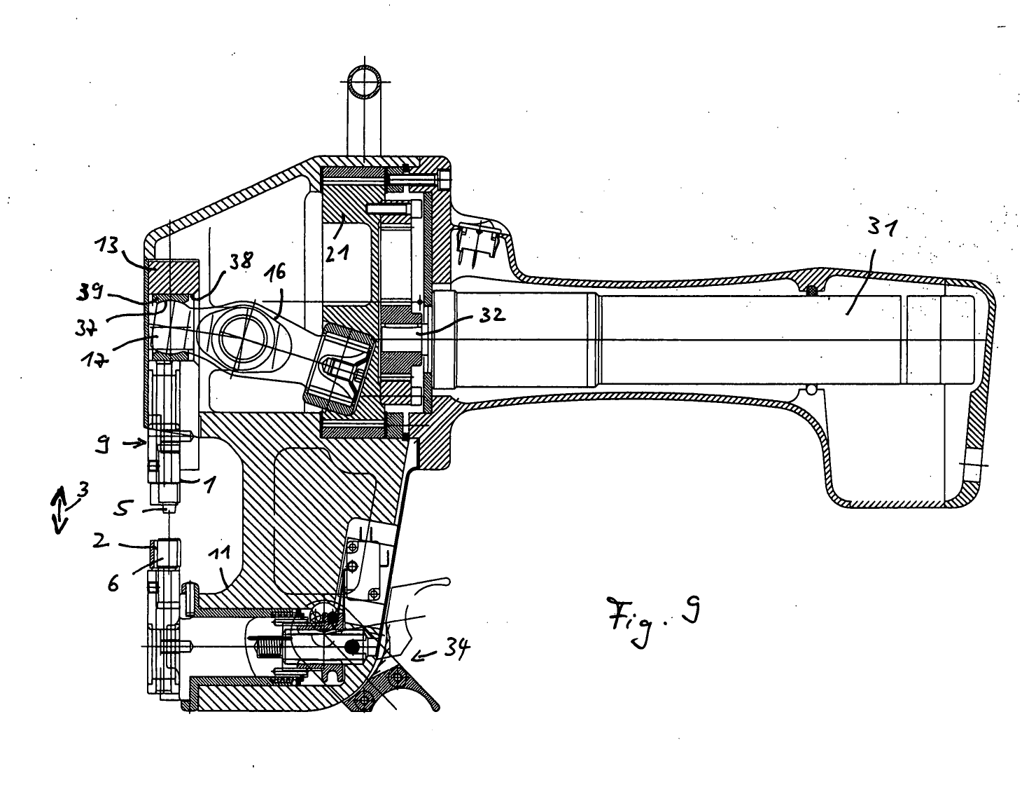

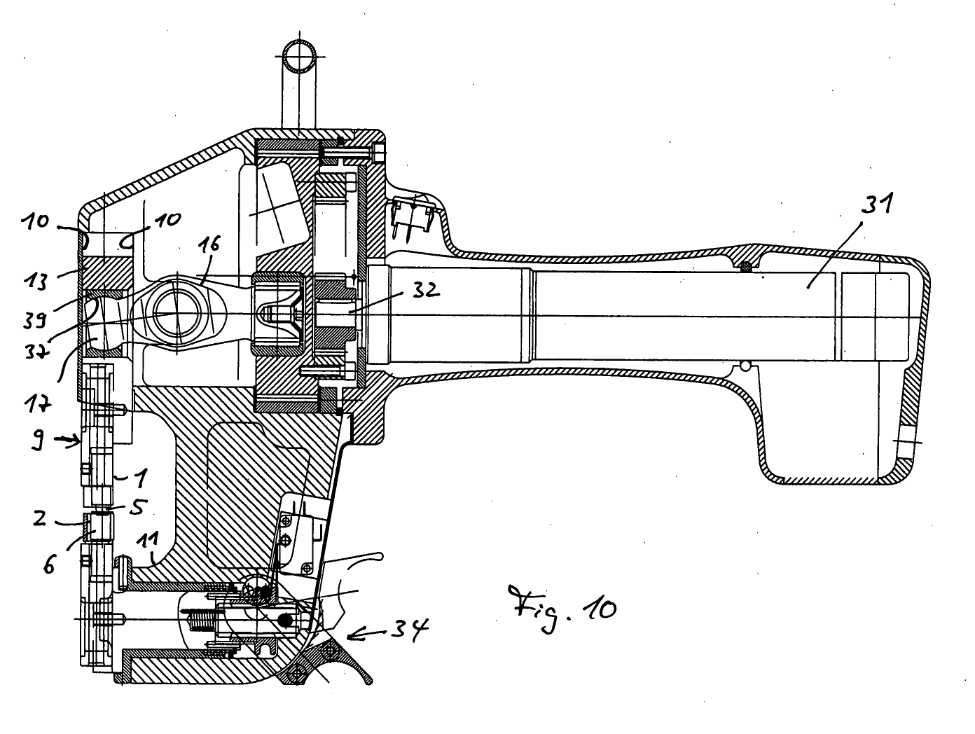

FIG. 9 schematically shows a longitudinal section of a third exemplary embodiment of a tool in the open position of the tool set,

FIG. 10 schematically shows the tool according to FIG. 9 in a working position.

FIGS. 1 and 2 show a first exemplary embodiment of a tool for the mechanical processing of workpieces, in particular for the joining, self-piercing riveting or clinching of sheet, tube or profile parts, having tool-insert carriers 1, 2 which are movable relative to one another and to the working ends of which a respective tool insert of a tool set can be fastened. The tool-insert carriers 1, 2 are movable relative to one another. The movement is effected linearly toward one another or away from one another according to the double arrow 3 shown in FIG. 2 in order to close the tool set in a working position or open it from the working position. Here, the tool set consists of a punch 5 and a die 4. The punch 5 and die 4 can be selectively assigned to the respective tool-insert carrier 1, 2. According to FIG. 1, the punch 5 is fastened to the tool-insert carrier 1 and the die 4 is fastened to the tool-insert carrier 2. Hold-downs 6, 7 are assigned to the die and punch 4, 5.

Here, the tool-insert carrier 2 which is provided on a bottom leg 11 is designed to be fixed. The leg 11 itself can be swung down in a lockable manner relative to a top leg 50 via a pivoting mechanism 34, for example for insertion or exchange of a tool set. The tool-insert carrier 1 which is provided on the top leg 50 is arranged on the working end of a plunger 9. For fastening a tool insert in the tool-insert carrier 1, a fastening means, for example a screw 8, may be provided. The plunger 9 is guided in a preferably closed guide, which is formed by opposite walls 10 on the top leg, for a rectilinear movement in a working stroke direction (arrow 3). The plunger 9 preferably comprises a working plunger 13 and a stroke plunger 14, which are displaceable relative to one another in the working stroke direction in order to be able to vary a basic feed of the plunger 9. The stroke plunger 14 and working plunger 13 are arranged relative to one another in such a way that the stroke plunger 14 forms an inner shell, on which the working plunger 13 is displaceable parallel to the guide of the plunger 9 as an outer shell having a larger outer shell length than the inner shell. Those sides of the stroke plunger 14 and the working plunger 13 which are remote from the shell surfaces together form a plunger 9 guided in a slide-like manner between the walls 10.

The stroke plunger 14 is connected to the working plunger 13 via an adjusting device, which may be formed by an adjusting spindle 15. The adjusting spindle 15 has an external thread which interacts with an associated internal thread in the working plunger 13 and in the stroke plunger 14. The thread of the adjusting spindle 15 for the working plunger 13 has a thread-turn orientation which is different from the thread of the adjusting spindle 15 for the stroke plunger 14. In addition, the pitch of the adjusting spindle 15 for the working plunger is greater than the pitch for the stroke plunger. By rotation of the adjusting spindle 15, the working plunger 13 and the stroke plunger 14 therefore approach one another in the working stroke direction or are moved away from one another. The adjusting device is actuated by a rotary knob 35 accessible from outside.

A latching disk 37 secured via a snap ring 36 and arranged concentrically around the adjusting spindle 15 may be provided for latching the position of the latter, this latching disk 37 being in engagement with the adjusting spindle 15. The latching disk 37 is rotated during a rotation of the adjusting spindle 15. For the latching, circumferentially arranged recesses in which a latching spring 38 engages are provided in the latching disk 37. The latching spring 38 is fixed in the working plunger 13 via a headless set screw 39.

The second exemplary embodiment of the tool shown in FIGS. 3 to 8 differs from the first exemplary embodiment shown in FIGS. 1 and 2 and described above merely in a different design of the actuating device for the adjusting device for the basic feed adaptation of the plunger 9, this actuating device being formed here by a hexagon socket screw 40. The hexagon socket screw 40 is accessible via an opening in the housing. It has an external thread which interacts with a corresponding internal thread in the working plunger 13 and in the stroke plunger 14. By turning the hexagon socket screw 40, the working plunger 13 and the stroke plunger 14 approach one another in the movement direction or are moved away from one another. In the region of the working plunger 13, the hexagon socket screw 40 is surrounded by a reducing nut 41, which is fixed in the working plunger 13 by a headless set screw 42. The reducing nut 41 forms a latching device with the head of the hexagon socket screw 40. Otherwise, the above comments with regard to the first exemplary embodiment correspondingly apply here.

The following comments with regard to the drive and further configuration of the tool apply to both the first exemplary embodiment in FIGS. 1 and 2 and the second exemplary embodiment according to FIGS. 3 to 8.

For an electric-motor drive, which acts on the plunger 9 of the at least one tool-insert carrier 1 for performing a working stroke, a cam disk 21 which can be driven by a shaft 32 of a motor 31 is provided as drive member, this cam disk 21 controlling a positive motion of a stroke member which is formed by a rocker 16. The rocker 16 is pivotably mounted about a fixed axis 16.1 perpendicularly to the working stroke direction of the plunger 9. The rocker 16 is designed in the manner of a double-armed lever and has two ends 17, 18. A free end 17, intended for transmitting a working stroke, of the rocker 16 is in engagement with the plunger 9. The end 17 is arranged on the plunger 9 via a bearing 19 in a sliding guide, as a result of which an oscillation angle of the end 17 of the rocker 16 relative to a plunger displacement in the working stroke direction is compensated for. For this purpose, the end 17 of the rocker 16 is of cylindrical or dome-shaped design and is arranged in an articulated manner in the bearing 19, which is displaceable in the sliding guide relative to the plunger 9 perpendicularly to the working stroke direction of the latter. During a pivoting movement of the rocker 16, the guided plunger 9 is subjected to a translatory movement.

When that end 17 of the rocker 16 which is mounted in the plunger 9 is swung up in the position shown in FIGS. 1 and 3, the plunger 9 is moved upward. When that end 17 of the rocker 16 which is mounted in the plunger 9 is swung down again in the position shown in FIGS. 1 and 3, the plunger 9 is moved downward. A maximum stroke of the plunger 9 can be set by the pivoting movement of the rocker 16.

For a force transmission as linear as possible, that end 17 of the rocker 16 which is mounted in the plunger 9 is preferably mounted essentially centrally in the plunger 9 relative to a guideway formed by the walls 10.

Alternatively, the engagement between rocker and plunger may also be effected by the plunger having a pin which is accommodated by an end of the rocker.

The rocker 16 is subjected to a positive motion which is controlled by the cam disk 21. For this purpose, the other end 18 of the rocker 16 rolls in a curved track 20 about a cam disk core 12 of the cam disk 21. For this purpose, this end 18 of the rocker 16 is preferably of journal-shaped design and is mounted in an inner ring 22 via needle rollers 23. The inner ring 22 is accommodated in a curved track 20 of preferably groove-shaped design. The inner ring 22 and the needle rollers 23 form a bush-shaped antifriction bearing for the journal-shaped end.

The rocker 16 may have ends 17, 18 which are fastened to arms of different length. That arm of the rocker 16 which carries the end 17 in engagement with the plunger 9 is preferably designed to be shorter than the arm which carries that end 18 of the rocker 16 which is positively driven on the cam disk 21.

The cam disk 21 is arranged so as to be rotatable about a fixed rotation axis 26 which lies perpendicularly to the working stroke direction of the plunger 9 and preferably lies perpendicularly to the pivot axis 16.1 of the rocker 16. The curved track 20 runs in a closed manner about the rotation axis 26 of the cam disk 21. The curved track 20 has a stroke H, defined by the cam disk core 12, for the end 18 of the rocker 16. Since the fixed axis 16.1 of the rocker 16 is arranged offset from the rotation axis 26 of the cam disk 21, the curved track 20 also has a varying inclination relative to the rotation axis 26 of the cam disk 21.

The plunger displacement for a working stroke can be set by a stroke H. A selectable offset of the axis 16.1 of the rocker 16 relative to the rotation axis 26 of the cam disk 21 in the working stroke direction can ensure that, at the end of the working stroke, i.e. when the maximum feed of the plunger 9 is reached, the rocker 16 is pivoted essentially perpendicularly to the working stroke direction, i.e. it is essentially horizontal according to FIG. 1 and FIG. 3.

The pivoting movement of the rocker 16 and thus the linear movement of the plunger 9 in the working stroke can be influenced by the configuration of the curved track 20 of the cam disk 21. Due to the guidance of that end 18 of the rocker 16 which is mounted in the cam disk 21, it is possible to preset the movement of the plunger 9, to be precise with regard to the feed travel and the feed rate, as a result of which, for example, quicker relief of force relative to loading in the working stroke or vice versa can be effected. This is because, in addition to the maximum stroke H of the cam disk core 12, the gradient of the curve can be individually selected, for which the curve profile sections 12.1 and 12.2 adjacent to the maximum stroke H can be utilized.

FIGS. 5a and 5b show the rocker 16 at the end of a working stroke in the working position. For this purpose, the end 18 has rolled along the curve section 12.2 from the maximum stroke H. The curve section 12.2, starting from the plateau-shaped curve section 12.3 of the maximum stroke H, exhibits a steep rise to begin with, which, up to the end of the working stroke shown in FIG. 5b, then ends in a flattened manner and in a curve section 12.4, which in FIG. 5b defines the end of the working stroke, namely return from the maximum stroke H. The curve section 12.1 is steep overall compared with 12.2. This enables the feed to be effected more slowly than the return stroke when high moments of force are to be applied. In addition, workpiece-related properties of the workpieces to be processed can be taken into account by the shaping of the profile of the curved track 20. The curved track 20 preferably comprises only one maximum stroke H. Alternatively, a plurality of maximum strokes during one revolution may also be provided.

The cam disk 21 is preferably mounted in a bearing ring 25 about a rotation axis 26 via a needle ring 24. The cam disk 21 is located in a fixed position in a housing via a stop disk 27 and a clamping flange 28.

The cam disk 21 has an internally toothed gear rim 29 which revolves around the center point and meshes with a gear 30. Via a shaft 32, the gear 30 can be rotated by a motor 31, which can be designed as a geared motor. The relative position of the gear 30 and of the motor 31 is preferably fixed. To this end, the motor 31 can be fixed and the gear 30 connected to the shaft 32 can be mounted in a fixed position via an antifriction bearing 33.

According to a design of the invention which is not shown, the cam disk may also have a curved track whose contour is followed by a cam follower on the end facing the cam disk. In this case, the rocker is spring-preloaded against the cam disk.

FIG. 3 shows the tool with a rocker 16 which is located at the end of the working stroke, as is also shown by FIGS. 5a and 5b.

FIG. 4 shows the tool with a rocker 16 which has been moved back from the working stroke and in which the tool set is open. The opening of the tool set can be set together with the working stroke of the plunger 9 via the pivot angle of the rocker 16 in a controlled manner by the cam disk 21. In this position, workpieces to be processed can be put between the tool inserts 4, 5 of the tool-insert carriers 1, 2.

FIG. 7 shows the tool with a plunger 9 whose working plunger 13 has been displaced into a topmost position relative to the stroke plunger 14 and thus defines a minimum adjustable basic feed position of the plunger 9 for a working stroke.

FIG. 8 shows the tool with a plunger 9 whose working plunger 13 has been displaced into a bottommost position relative to the stroke plunger 14 and thus defines a maximum adjustable basic feed position of the plunger 9 for a working stroke.

The third exemplary embodiment shown in FIGS. 9 and 10 differs from the first exemplary embodiment in that the plunger 9 only comprises a working plunger 13, which is movable between the walls 10 in the working stroke direction (arrow 3). The free end 17, intended for transmitting a working stroke, of the rocker 16 is in engagement with the plunger 9. For this purpose, the end 17 of the rocker 16 is of dome-shaped design. The articulation of the end 17 on the plunger 9 is effected via an eccentric ball bush 39 which is movable in a guide 38 of the working plunger 13 perpendicularly to the working stroke direction. The eccentric ball bush 39 preferably takes hold of only a spherical segment of the dome-shaped end 17 of the rocker 16.

To simplify the manipulation, the shaft 32 of the motor 31 drives the cam disk 21 while being coupled to a bottom section of the cam disk 21.

A known pivoting mechanism 34 is provided for swinging down the bottom leg 11.

1-15. (canceled)

16. A tool for the mechanical processing of workpieces, in particular for the joining, self-piercing riveting or clinching of sheet, tube or profile parts, having tool-insert carriers which are movable relative to one another and to the working ends of which a respective tool insert of a tool set can be fastened, and having an electric-motor drive which acts on a plunger of at least one tool-insert carrier for performing a working stroke, the drive comprising as drive member a cam disk which can be driven by a shaft of a motor and controls a positive motion of a stroke member which is formed by a rocker which is pivotably mounted about a fixed axis perpendicularly to a working stroke direction of the movable tool-insert carrier and whose free end moves a plunger guided in the working stroke direction.

17. The tool as claimed in claim 16, the plunger of the driven tool-insert carrier having a bearing which compensates for an oscillation angle relative to a plunger displacement and which accommodates a free end, designed for a transmission of motion, of the rocker.

18. The tool as claimed in claim 17, the free end of the rocker being of cylindrical design and the bearing being guided in a sliding manner on the plunger.

19. The tool as claimed in claim 17, the free end of the rocker being of dome-shaped design, and an eccentric ball bush having a spherical bearing surface for a spherical segment of the free end being provided as bearing.

20. The tool as claimed in claim 16, the rocker being formed by a double-armed lever, the lever arm lengths of which are selectable for setting a certain plunger displacement.

21. The tool as claimed in claim 20, the lever arms being of different length.

22. The tool as claimed in claim 20, that lever arm of the rocker which carries the free end being designed to be shorter than the other lever arm, rolling with its end on the cam disk, of the rocker.

23. The tool as claimed in claim 16, that end of the rocker which is in engagement with the cam disk being journal-shaped and being mounted in a curved track of groove-shaped design of the cam disk.

24. The tool as claimed in claim 23, the journal-shaped end of the rocker rolling on the cam disk via an inner ring having needle rollers.

25. The tool as claimed in claim 16, the pivot axis of the rocker running perpendicularly and with an offset relative to a rotation axis of the cam disk.

26. The tool as claimed in claim 16, the plunger comprising a working plunger and a stroke plunger which are displaceable relative to one another in the working stroke direction via an adjusting device.

27. The tool as claimed in claim 26, a basic feed setting of the plunger being varied via a thread having different pitches of the adjusting device in the region of the working plunger and the stroke plunger.

28. The tool as claimed in claim 16, the curved track of the cam disk having gradient profiles, the gradient profile for a forward stroke being different from the gradient profile for a return stroke of a working stroke.

29. The tool as claimed in claim 16, the top and bottom legs forming the legs of hand pliers, it being possible for the bottom leg to be swung down in a lockable manner via an articulation.

30. The tool as claimed in claim 19, it being possible for the eccentric ball bush to be fixed in an adjustable manner in a guide of the plunger.
